(19) United States
(12) Patent Application Publication
(10) Pub. No.: US 2014/0327915 A1
(43) Pub. Date: Nov. 6, 2014

(54) WELL MONITORING USING COHERENT DETECTION OF RAYLEIGH SCATTER

(71) Applicant: Roger Glen Duncan, Christiansburg, VA (US)

(72) Inventor: Roger Glen Duncan, Christiansburg, VA (US)

(73) Assignee: Baker Hughes Incorporated, Houston, TX (US)

(21) Appl. No.: 13/886,929

(22) Filed: May 3, 2013

(51) Int. Cl. G01V 8/00

(52) U.S. Cl. CPC G01V 8/00
USPC 356/477

(57) ABSTRACT

Disclosed herein is a system for measuring characteristics in a well bore. The system includes a fiber-optic wire extending along a length of the well bore a monitoring system. The monitoring system includes a swept-wavelength interferometer (SWI) configured to transmit light into the fiber-optic wire by sweeping the light across a range of wavelengths, and the monitoring system is configured to detect a characteristic in the well bore based on detecting a Rayleigh backscatter of the light transmitted into the fiber-optic wire.

### BACKGROUND OF THE INVENTION

In oil and gas drilling and completion systems, sensors monitor drill pipe, completion structures and surrounding environments to detect conditions and characteristics of a well bore and drilling and completion systems. Optical fibers are gaining acceptance as sensors in the oil and gas industry for monitoring a variety of parameters for production optimization, well integrity monitoring or other applications.

### BRIEF DESCRIPTION OF THE INVENTION

Disclosed herein is a system for measuring characteristics in a well bore. The system includes a fiber-optic wire extending along a length of the well bore a monitoring system. The monitoring system includes a swept-wavelength interferometer (SWI) configured to transmit light into the fiber-optic wire by sweeping the light across a range of wavelengths, and the monitoring system is configured to detect a characteristic in the well bore based on detecting a Rayleigh backscatter of the light transmitted into the fiber-optic wire.

Further disclosed herein is a method of measuring a characteristic in a well bore. The method includes transmitting light into an optical fiber extended into a well bore and measuring a Rayleigh backscatter corresponding to the transmitted light by sweeping the light across a range of wavelengths over time. The method also includes determining a characteristic in the well bore based on the Rayleigh backscatter.

### BRIEF DESCRIPTION OF THE DRAWINGS

The following descriptions should not be considered limiting in any way. With reference to the accompanying drawings, like elements are numbered alike:

FIG. 1 illustrates a well bore monitoring system according to one embodiment of the invention;

FIG. 2 illustrates a well bore monitoring system according to another embodiment;

FIG. 3 illustrates a well pipe and optical fiber according to an embodiment of the invention;

FIG. 4 illustrates a well pipe and optical fiber according to another embodiment;

FIG. 5 illustrates a well pipe and optical fiber according to another embodiment; and

FIG. 6 illustrates a method of monitoring a characteristic in a well bore according to an embodiment of the invention.

### DETAILED DESCRIPTION OF THE INVENTION

A detailed description of one or more embodiments of the disclosed apparatus and method are presented herein by way of example and not limitation with reference to the Figures.

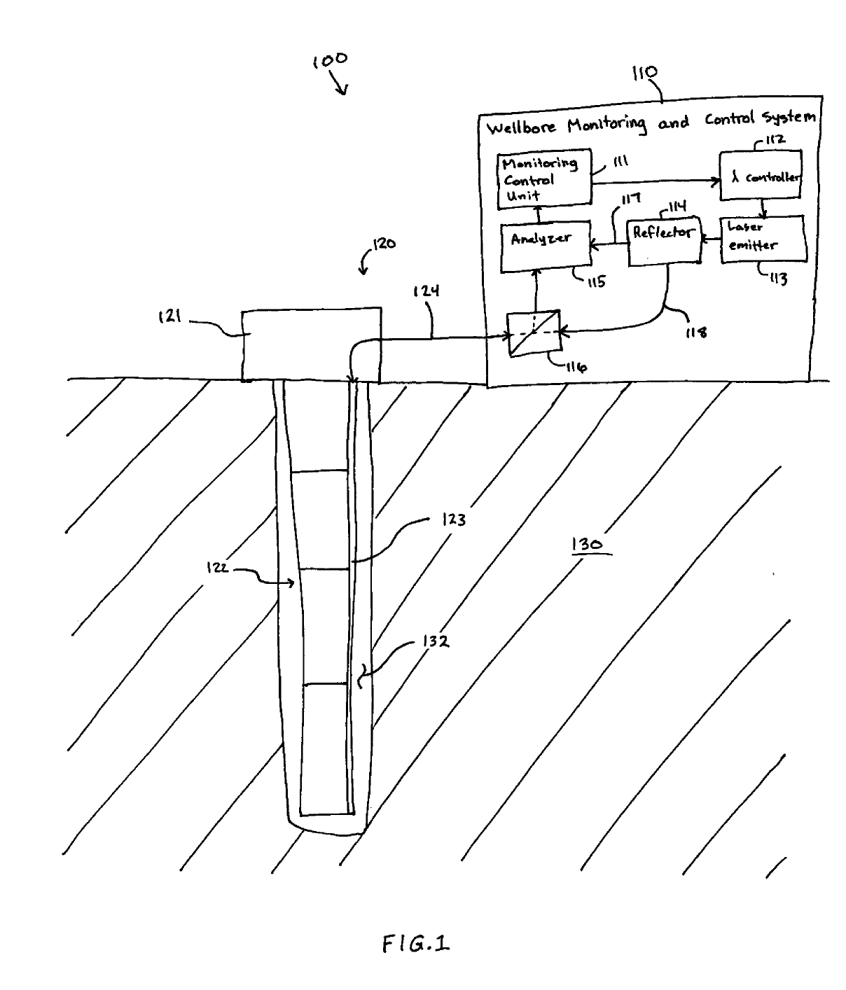

Referring to FIG. 1, a system 100 for monitoring a characteristic in a well bore includes a well bore monitoring and control system 110 and a well structure 120. The well structure 120 may be a drill or a completion structure. FIG. 1 illustrates a completion structure including a cap 121, a pipe 122 including a plurality of tubular segments, and a cable 123 extending along a length of the well structure 120. The well structure 120 is located within a well bore 132 formed in a geological formation 130. In one embodiment, the cable 123 is located on or in a well pipe 122. However, in an alternative embodiment the cable 123 extends along the well bore 132 independently of a well pipe.

The cable 123 includes a fiber-optic wire, or an optical fiber, and may also include one or more protective coating layers. In one embodiment, a single cable 123 and a single optical fiber in the cable 123 extend along substantially an entire length of the pipe 122. In another embodiment, a single cable 123 and a single optical fiber in the cable 123 extend along a length of the pipe 122 less than an entire length of the pipe 122. For example, in one embodiment, only a deepest portion of the pipe 122 is monitored by attaching the cable 123 to the monitored portion, while a shallowest portion of the pipe 122 does not include the cable 123. In such an embodiment, one or more components of the well bore monitoring and control system 110 are located downhole in the well bore 132.

In one embodiment, a cable 123 includes therein multiple optical fibers extending along the length of the pipe 122. In another embodiment, multiple cables 123 and multiple optical fibers extend along the length of the pipe 122. In other words, multiple cables and optical fibers may extend along the length of the pipe 122, but each of the multiple fibers extends from a first end into which light is transmitted to an opposite end corresponding to an end of a monitored portion of the pipe 122.

In yet other embodiments, multiple cables 123, or multiple optical fibers, are connected end to end, such as by repeaters or other connectors to make up a length of the cable 123 along the monitored portion of the pipe 122.

The well bore monitoring and control system 110 transmits light into an optical fiber of the cable 123 and detects Rayleigh backscatter from the transmitted light to determine characteristics in the well bore 132, such as characteristics of the pipe 122. Examples of determined characteristics include strain, temperature, vibration, acoustics, deformation and compaction. However, any characteristic of the pipe having a defined relationship with the optical fiber of the cable 123 may be detected, such that changes in the determined characteristics (e.g., strain, temperature, etc.) result in changes in the characteristics of the optical fiber. In addition, in one embodiment, characteristics of the well bore 132, geological formation 130 or fluid in the well bore 132, such as oil, gas, or drilling fluid, may be determined.

The well bore monitoring and control system 110 includes a monitoring control unit 111 including a processing circuit, memory, logic circuits, data communication ports and other processing and communications circuitry. The monitoring control unit 111 may receive data, commands and other inputs from external sources, such as external systems, users or computer readable media, such as external memory drives or disks. The monitoring control unit 111 may also receive data and commands from internal memory, such as hard disks, and other volatile and non-volatile memory.

The monitoring control unit 111 controls the transmission of light to an optical fiber 124 by controlling a wavelength controller 112. The monitoring control unit 111 receives data corresponding to reflected light including data corresponding to Rayleigh backscatter in the optical fiber in the cable 123 and determines characteristics of one or more of the pipe 122, well bore 132, including fluid in the well bore 132, and geological formation 130 based on the data corresponding to the backscattered light.

In one embodiment, the wavelength controller 112 is an adjustable power supply or a command module that is configured to receive instructions or signals from the monitoring control unit 111 and to generate an output command signal or power signal that changes to cause the laser emitter 113 to sweep through a range of wavelengths of light. In one embodiment, the laser emitter is a tunable light source, such as a tunable laser emitter. The monitoring control unit 111 may control the wavelength controller 112 to cause the laser emitter 113 to sweep through a range of wavelengths, so that light transmitted into the optical fiber is continuously changing in an incrementally-ascending manner or an incrementally-descending manner. In other words, the light emitted from the laser emitter 113 may continuously sweep through a range of frequencies from a low end to a high end, then from the high end to the low end.

While an embodiment has been described in which the laser emitter 113 sweeps through a range of wavelengths in a continuous manner, in other embodiments the laser emitter 113 sweeps through the range of wavelengths in a non-continuous manner, such as at varying intervals of time, based on user controls, or in any other manner.

A portion of the light emitted from the laser emitter 113 is reflected by a first beam splitter 114, which may also be referred to as a reflector 114, to generate two beams of light. The first beam, which may be referred to as a reference beam, is transmitted along a reference line 117. The second beam, which may be referred to as a measurement beam, is transmitted along a measurement line 117. The measurement line 117 is connected to 50/50 coupler 116, which transmits the measurement beam into the test line 124, which continues into the cable 123. Rayleigh backscatter is transmitted back from the cable 123 through the test line 124 and the 50/50 coupler 116 to the analyzer 115. The Rayleigh backscatter and the reference beam are both transmitted into the analyzer 115, which may include one or more light sensors, filters comparators, processing circuitry and other elements and circuitry to compare the Rayleigh backscatter with the corresponding reference beam. The resulting data is transmitted to the monitoring control unit 111 to store or transmit to an external device, system or user.

In particular, the changes in the local period of the Rayleigh backscatter caused by external stimuli, such as strain, bending or changes in temperature of the optical fiber in the cable 123, cause shifts in a locally-reflected spectrum. The local spectral shifts may be calibrated and assembled, such as by the analyzer 115, to form a distributed characteristic measurement, such as a strain, temperature, compaction, bending, vibration or pressure measurement.

The wavelength controller 112, laser emitter 113, reflector 114, and 50/50 coupler 116, the reference line 117, the measurement line 118 and the test line 124 together make up a swept-wavelength interferometer (SWI). Generally, an SWI generates light along a series of wavelengths and detects optical fiber characteristics by sweeping the light along a range of wavelengths, splitting the light into a reference beam and a test beam, and comparing the reference beam with light reflected from the optical fiber that corresponds to the test beam. Although one example of an SWI is illustrated in FIG. 1, embodiments of the invention encompass any SWI including additional components or different components. For example, in one embodiment, the SWI further includes beam polarization detectors and polarization controllers to monitor and control polarization characteristics of the transmitted beams.

While FIG. 1 illustrates one cable 123 extending along the pipe 122, in another embodiment, multiple cables 123 or optical fibers extend along the same length of a pipe 122. In one embodiment, the multiple cables 123 or optical fibers are located on different circumferential portions of the pipe 122, such as on opposite circumferential sides of the pipe 122. In one embodiment, the multiple cables 123 or optical fibers have different shapes along the pipe 122. For example, one of the multiple cables 123 or optical fibers may extend straightly along the pipe 122 while another one of the multiple cables 123 or optical fibers may wrap around pipe 122 in a helical shape along the length of the pipe 122. In another embodiment, one cable 123 has a shape, such as a helical shape, at a first portion of the well pipe 122 while the other cable 123 has a different shape, such as a straight shape, along the same portion of the well pipe 122. In another portion of the well pipe 122, the shapes of the cables 123 may alternate, such that each cable 123 is configured to generate unique Rayleigh backscatter patterns at different depths relative to each other cable 123. In one embodiment, the different measurements of the multiple cables 123 or optical fibers are analyzed and compared by the analyzer 115 to determine different characteristics of the pipe 122, well bore 132 or geological formation 130.

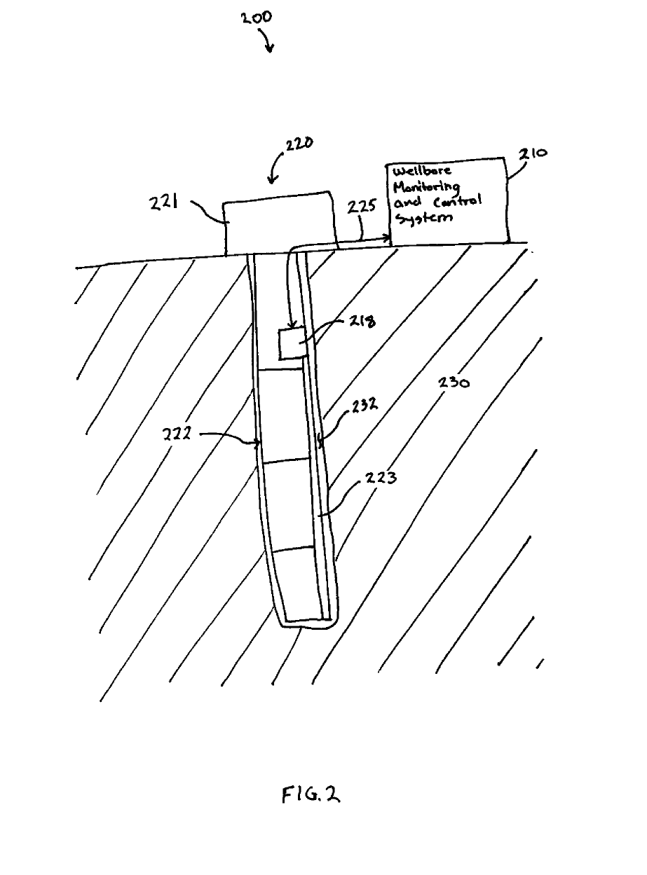

FIG. 2 illustrates a well bore monitoring system 200 according to another embodiment of the invention. The well bore monitoring system 200 includes a well bore monitoring and control system 210 and a well structure 220. The well structure 220 includes a cap 221 on a surface of a well bore 232 formed in a geological formation 230 and a pipe 222 extending into the well bore 232. A fiber optic line 225, or an optical fiber 225, extends from the well bore monitoring and control system 210 to a measurement component 218. A fiber optic test line extends in a cable 223 along a length of the pipe 222.

The measurement component 218 includes one or more of a laser emitter, a reflector, a reference line, 50/50 coupler and a light analyzer. In other words, the well bore monitoring and control system 210 and the measurement component 218 together include all the components illustrated in the well bore monitoring and control system 110 of FIG. 1. In FIG. 2, one or more of the components for performing the swept-wave interferometry are located downhole in the well bore 232. The farther from the reflector (such as the reflector 114 of FIG. 1) that Rayleigh backscatter occurs, the higher the frequency of backscatter that is generated. By locating one or more measurement components 218 in the well bore 232, a distance between the measurement component 218 and a tested portion of fiber optic line is reduced, permitting measurement to an increased depth within a well bore 232.

In one embodiment, the measurement component 218 is affixed to the pipe 222, such as within a sealed casing that may be integral to the pipe 222, welded to the pipe 222, connected by bolts or by any other fixing mechanism. In one embodiment, the measurement component includes multiple components distributed along a length of the pipe 222. In another embodiment, the measurement component 218 includes multiple elements all located within a same sealed body in the well bore 223.

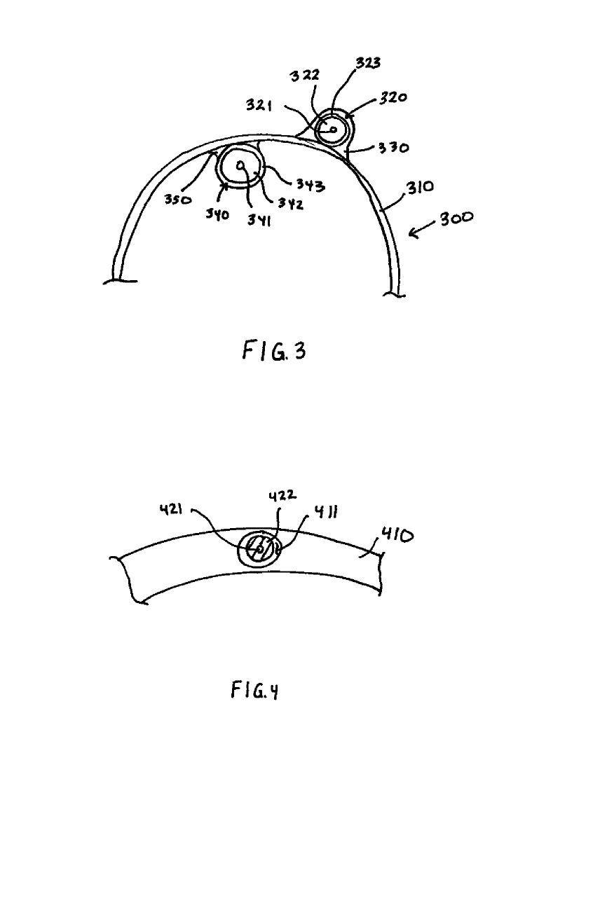

FIG. 3 illustrates a well pipe assembly 300 according to one embodiment. The well pipe assembly 300 includes a pipe 310 and optical fibers 330 and 340 affixed to the pipe. The optical fiber 330 includes a core 321, cladding 322 and a carbon coating 323 surrounding the cladding 322. A fixing material 330, such as an adhesive or other fixing material is formed to surround the optical fiber 330. The optical fiber 330 is located on an outside radial surface of the pipe 310. The optical fiber 340 includes a core 341, cladding 342 and carbon coating 323 surrounding the cladding 342. An adhesive or weld 350 is formed between the optical fiber 340 and the pipe 310 to affix the optical fiber 340 to the pipe 310.

As illustrated in FIG. 3, an optical fiber configured to detect characteristics of a well pipe, such as the pipe 310, or of a well bore or earth formation, may be attached to an outer surface or an inner surface of the pipe 310. For example, in one embodiment the optical fiber 320 located on an outside surface of the pipe 310 is configured to measure characteristics of one or more of a pipe 310 characteristic, well bore fluid characteristic or geological formation characteristic. In addition, the optical fiber 340, located on an inside surface of the pipe 310, is configured to detect characteristics of one or both of the pipe 310 and internal fluid of the pipe 310.

Since contaminants, such as hydrogen, deteriorate performance and physical characteristics of the optical fibers 320 and 340, the carbon coating 323 and 343, respectively, protects the cladding and core layers 322, 342, 321 and 341. In a system that measures drill pipe characteristics based on Rayleigh backscatter, such a carbon coating 323 and 343 is possible, since no special manufacturing steps are required to make a fiber optic cable suitable for Rayleigh backscatter. In contrast, systems utilizing other types of sensing methods, such as Fiber Bragg Gratings may require manufacturing steps that make the formation of the carbon coating difficult or impossible. For example, since carbon coating is applied at a high temperature, the application of the carbon coating may damage or destroy Fiber Bragg Gratings in an optical fiber.

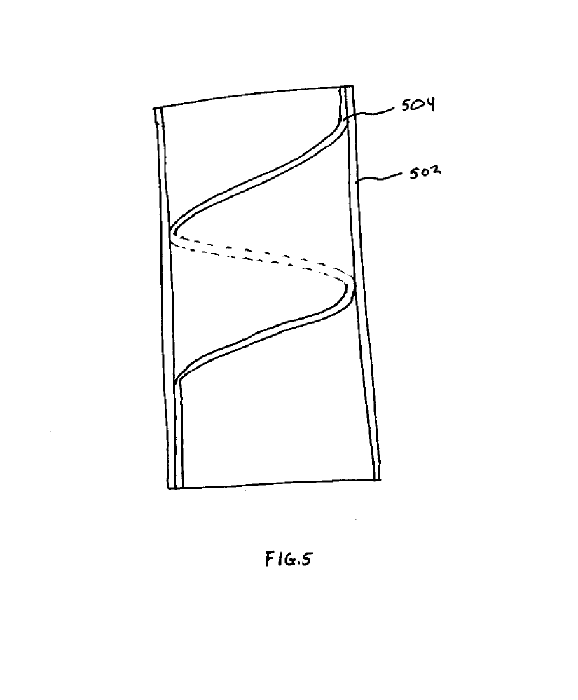

FIG. 4 illustrates a segment of a drill pipe 410 according to another embodiment. In FIG. 4, an optical fiber including a core 421 and cladding 422 is located in a cavity 411 within a wall of the pipe 410.

An optical fiber, or a cable including an optical fiber, may be arranged in any manner along a length of a well pipe to detect characteristics of the well pipe, fluid inside the well pipe, fluid outside the well pipe and characteristics in a surrounding geological formation. In one embodiment, as illustrated generally in FIG. 1, an optical fiber extends in a substantially straight and linear manner along the length of a well pipe. FIG. 5 illustrates a configuration of an optical fiber according to another embodiment. FIG. 5 is a side cross-section view of a well pipe 502 and optical fiber 504. The optical fiber 504 is arranged helically within a well pipe 502, where the dashed lines represent a portion of the optical fiber 504 in the cut-away portion of the well pipe 502. In one embodiment, the helical configuration is used to measure a strain of a portion of well pipe. In one embodiment, different portions of an optical fiber are arranged differently within a same well pipe to generate different Rayleigh backscatter patterns, or to measure characteristics of different portions of well pipe in different ways.

Other configurations of optical fiber encompassed by embodiments of the invention include loops around a circumference of the well pipe, loops along an axial direction of the well pipe, optical fiber arranged in alternating axial directions to form a substantially sinusoidal pattern around a circumference of a portion of the well pipe or any other configuration of optical fiber around or along the well pipe.

In one embodiment, multiple optical fibers extend along a same length of the same well pipe. In one embodiment, the multiple optical fibers have a same shape, such as a straight line, a helical shape, a sinusoidal shape, or any other shape. In another embodiment, the multiple optical fibers have different shapes along different portions of the well pipe. For example, a first optical fiber may extend straightly along a portion of the well pipe while another optical fiber has a helical configuration along the same portion of the well pipe. Accordingly, different measurements corresponding to different characteristics may be obtained within a same length of well pipe.

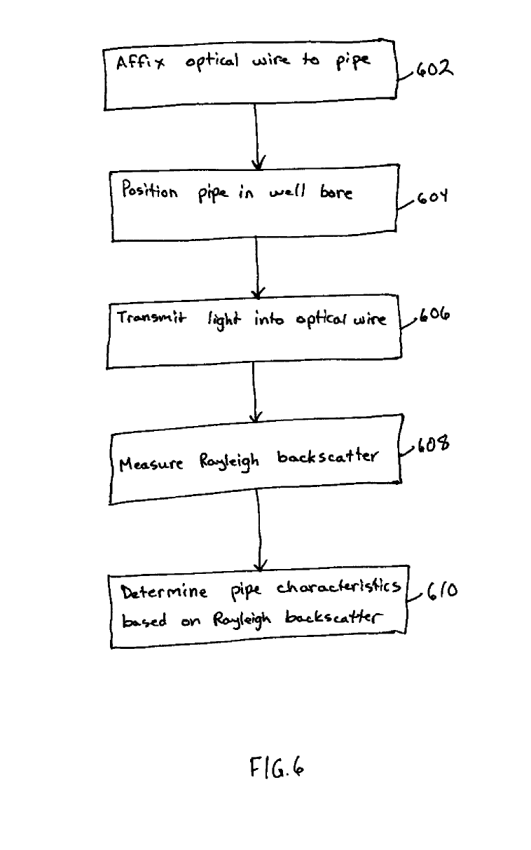

FIG. 6 illustrates a flow diagram of a method according to an embodiment of the invention. In block 602 an optical wire or fiber is affixed to a pipe. The optical wire or fiber may be located within a cable or may be affixed directly to the pipe. In one embodiment, the pipe includes multiple segments connected end-to-end, while the optical wire or fiber includes only one wire extending along an entire length of the pipe, or across multiple different segments of the pipe. In one embodiment, the pipe is assembled segment-by-segment at an opening of a well bore, and the optical wire is reeled and attached to the pipe as the pipe is assembled. In another embodiment, the optical wire or fiber is segmented and different segments of the optical fiber or wire are connected with connectors, repeaters, filling material or any other mechanism or material for connecting different segments of optical fiber.

In block 604, the pipe is positioned in a well bore. For example, the multiple separate tubular segments may be connected end-to-end and inserted into the well bore, such that the pipe within the well bore is one continuous pipe made up of connected tubular segments, while outside the well bore, the separate tubular segments remain unconnected. In one embodiment, blocks 602 and 604 are performed simultaneously. In other words, as the pipe segments are assembled into a contiguous pipe structure, the optical wire or fiber is unspooled and affixed to the upper-most portion of the contiguous pipe structure.

In block 606, light is transmitted into the optical wire. For example, as illustrated in FIGS. 1 and 2, a tunable light source or a tunable laser source may be controlled to sweep light across a range of frequencies, the light may be divided into a reference light beam and a test light beam, the reference light beam may be directed to an analyzer, such as a light sensor and processing circuit, without traveling downhole in the well bore, and the test light beam may be transmitted downhole into the well bore.

In block 608, a Rayleigh backscatter is measured from the test beam directed downhole into a well bore. In particular, the test beam may be directed into an optical fiber running along the well pipe in a downhole direction and Rayleigh backscatter may be transmitted uphole in response to the test beam transmitted downhole. In block 610, the Rayleigh backscatter and the reference beam are compared to determine characteristics of the well pipe. In particular, the changes in the local period of the Rayleigh backscatter caused by external stimuli, such as strain, bending or changes in temperature of the optical fiber, cause shifts in a locally-reflected spectrum. The local spectral shifts may be calibrated and assembled by an analyzer to form a distributed measurement of a characteristic of the well pipe. Examples of characteristics that may be measured by the comparison of the Rayleigh backscatter and the reference beam include pipe strain, bending, vibration or compaction as well as temperature.

In embodiments of the invention, characteristics of a well bore are determined using Rayleigh backscatter. Since no special manufacturing processes are required on a fiber optic wire, a carbon coating may be used to protect the fiber optic wire from contaminants, such as hydrogen. The use of the Rayleigh backscatter to determine characteristics in the well bore allows for a high spatial resolution. For example, a site of strain or bending in a well pipe may be identified within a range of 10 centimeters over a 1000 meter range of well pipe. In embodiments of the present disclosure, a length of a well pipe to be tested based on the Rayleigh backscatter may be limited by a signal-to-noise ratio and sampling limitations. For example, a length of well pipe may extend from around 300 meters to around 15 to 20 kilometers. In some embodiments, a frequency of light generated by a light source is in a range from around 10 megahertz (MHz) to around 70 gigahertz (GHz). However, embodiments of the present invention are not limited to the above lengths and frequencies, but encompass a well pipe and optical fiber of any length and light of any frequency and range of frequencies according to available hardware and design requirements.

Since Rayleigh backscatter generates light at higher frequencies the farther from the reflector that the backscatter occurs, embodiments of the present invention include one or more of a laser emitter, a reflector, a reference line, 50/50 coupler and a light analyzer located within a well bore.

Embodiments of the present invention further include an SWI configured to sweep across a range of light wavelengths to generate the Rayleigh backscatter in the optical wire.

While the invention has been described with reference to example embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiments disclosed as the best mode contemplated for carrying out this invention, but that the invention will include all embodiments falling within the scope of the claims.

What is claimed is:

1. A system for measuring characteristics in a well bore, comprising:
a fiber-optic wire extending along a length of the well bore; and
a monitoring system including a swept-wavelength interferometer (SWI) configured to transmit light into the fiber-optic wire by sweeping the light across a range of wavelengths, and the monitoring system configured to detect a characteristic in the well bore based on detecting a Rayleigh backscatter of the light transmitted into the fiber-optic wire.

2. The system of claim 1, further comprising:
a pipe positioned in the well bore, wherein the monitoring system is configured to detect a characteristic of the pipe based on the detecting of the Rayleigh backscatter.

3. The system of claim 2, wherein the characteristic detected by the monitoring system is at least one of a strain, a deformation and a compaction of the pipe.

4. The system of claim 2, wherein the characteristic is a vibration of the pipe.

5. The system of claim 2, wherein the fiber-optic wire is a single wire extending along an entire length of the pipe in the well bore.

6. The system of claim 2, wherein the fiber-optic wire is attached to a surface of the pipe.

7. The system of claim 2, wherein the fiber-optic wire is arranged in a helical shape on a surface of at least a portion of the pipe.

8. The system of claim 1, wherein the characteristic is a temperature in the well bore.

9. The system of claim 1, wherein the SWI includes a reflector to divide the light into a reference beam and a test beam, and at least one of the reflector and a reference wire for transmitting the reference beam uphole without being transmitted downhole is located in the well bore.

10. The system of claim 1, wherein the fiber-optic wire includes a carbon coating coated onto a cladding of the fiber-optic wire.

11. A method of measuring a characteristic in a well bore, the method comprising:
transmitting light into an optical fiber extended in a well bore by sweeping the light across a range of wavelengths over time;
measuring a Rayleigh backscatter corresponding to the light transmitted into the optical fiber; and
determining a characteristic in the well bore based on the Rayleigh backscatter.

12. The method of claim 11, wherein the characteristic is at least one of a strain, a deformation and a compaction of a well pipe in the well bore.

13. The method of claim 11, wherein the characteristic is a vibration of a well pipe in the well bore.

14. The method of claim 11, wherein the characteristic is a temperature of a well pipe in the well bore.

15. The method of claim 11, further comprising:
generating a reference signal by reflecting, by a reflector, a portion of the light transmitted into the optical fiber to an analysis unit from a location inside the well bore; and
comparing the reference signal to the Rayleigh backscatter to determine the characteristic in the well bore.

16. The method of claim 11, wherein the optical fiber includes a carbon coating coated onto a cladding layer of the optical fiber.

17. The method of claim 11, wherein the optical fiber is a single wire extending along an entire length of a well pipe in the well bore.

18. The method of claim 11, further comprising:
connecting two or more separate tubulars to form a well pipe;
affixing the optical fiber to the well pipe; and
inserting the well pipe with the optical fiber affixed into the well bore.

19. The method of claim 11, further comprising:
affixing the optical fiber to a well pipe to have a helical shape on a surface of at least a portion of the well pipe, and
inserting the well pipe with the optical fiber affixed into the well bore.
